(19) United States
(12) Patent Application Publication
(10) Pub. No.: US 2016/0063450 A1
(43) Pub. Date: Mar. 3, 2016

(54) Systems and Methods for Task Countdowns for Specified Tasks

(71) Applicant: GOOGLE INC., Mountain View, CA (US)

(72) Inventors: Jacqueline Amy TSAY, Mountain View, CA (US); Timothy Youngjin SOHN, Mountain View, CA (US); Vijay UMAPATHY, Sunnyvale, CA (US)

(21) Appl. No.: 14/472,335

(22) Filed: Aug. 28, 2014

(51) Int. Cl. G06Q 10/10

(52) U.S. Cl. CPC G06Q 10/1095; G06Q 10/107

(57) ABSTRACT

A method of task management executes at a computing device having one or more processors and memory. The memory stores one or more programs configured for execution by the one or more processors. A user interface for a messaging application is displayed. The interface comprises an electronic message list panel comprising a plurality of listed objects. At least one such listed object represents (i) one or more electronic messages or (ii) a task. A task description is obtained. In some instances this task description is received from the user through the user interface. In some instances this task description is obtained from an object in the plurality of listed objects. An event within the task description is identified. An event date for the event is identified. The plurality of objects is updated to include an object that provides a representation of the event date and the task.

### TECHNICAL FIELD

The disclosure relates generally to electronic messaging applications, and more specifically to providing task management in the form of a representation of an event date associated with a task.

### BACKGROUND

Electronic messaging applications, such as email, convey various types of information to a recipient such as messages to and from various others. Some messages include a task that the recipient must perform. As such, many messaging applications track not only messages received by or sent by a recipient but also tasks that the recipient is to perform. Such tasks may be independent of messages to and from others, or associated with messages from others. What are needed in the art are systems and methods for assisting a recipient with performing such tasks.

### SUMMARY

Disclosed implementations address the above deficiencies and other problems associated with performing tasks. The disclosed implementations provide ways to help a recipient perform tasks. In particular, the disclosed systems and methods identify an event within such tasks and an event date for such events.

In accordance with some implementations, a method of task management executes at a computing device having one or more processors and memory. The memory stores one or more programs configured for execution by the one or more processors. A user interface for a messaging application is displayed. The user interface comprises an electronic message list panel comprising a plurality of listed objects for a recipient. Each respective object in the plurality of listed objects is visually distinct. An object in the plurality of listed objects represents (i) one or more corresponding electronic messages in a plurality of electronic messages or (ii) a task. Typically, the plurality of listed objects includes one or more individual messages, one or more message clusters, one or more tasks, as well as other forms of messages. A description of a task is obtained. This description of a task can be obtained from an existing object or can be received from the user through the user interface. For example, the description of the task can be determined from an email message or a task in the electronic message list.

Responsive to obtaining the description of the task, an event within the description of the task is identified independent of user intervention (e.g., automatically). Further, an event date for the event is identified. The plurality of objects displayed in the user interface is updated to include an object that provides a representation of the event date and the task. In some instances, this updating involves adding a new object to the plurality of objects that includes the representation of the event date and the task. For example, in instances where the description of the task was received from the user through the user interface, the updating would add a new object to the plurality of objects. On the other hand, if the task was obtained from an existing object in the original plurality of objects (e.g., a message or a task), the updating of the plurality of objects acts to update the existing object to include the event date (and possibly the description of the task if the original object did not explicitly define the task).

In some instances, identifying the event date comprises identifying the event date based upon the description of the task and stored information associated with the recipient. Examples of stored information associated with the recipient include, but are not limited to, geographical location associated with the recipient, country state and/or county associated with the recipient, recipient interests, recipient contacts, and recipient demographics, to name a few.

In some instances, the representation of the date comprises the event date. As example, the event is Saint Patrick's Day and the first date is the date of Saint Patrick's day. In some instances, the representation of the date comprises a countdown to the event date. Using the above example, Saint Patrick's day, the event date would be the number of days remaining until Saint Patrick's day.

In some instances, the identifying the event within the description of the task uses non-transient stored geographic information about the recipient to identify the event. For example, if the task description is “pay taxes”, geographic information identifying the recipient as associated with the United States would help to identify the event as the date in which United States federal income tax returns are due. As another example, if the task description is “pay state taxes”, geographic information identifying the recipient as associated with California would help to identify the event as the date in which California income tax returns are due. As still another example, if the task description is “pay property taxes”, geographic information identifying the recipient as associated with the county of Contra Costa in California would help to identify the event as the date in which Contra Costa county property taxes are due. As the above examples show, in some instances the non-transient stored geographic information about the recipient is a residence of the recipient.

In some instances, identifying the event date comprises retrieving a stored collection of enumerated events, where each respective enumerated event in the stored collection of enumerated events is associated with an event date. The event is then matched to an enumerated event in the stored collection of enumerated events. In some such instances, the stored collection of enumerated events comprises one or more public events such as a tax filing deadline, a deadline to register to vote, a deadline to vote in public election, a public holiday, or a ticketed event. As such, in some embodiments, there is a form of look-up table that provides, for each respective event of a number of events, the associated event date for the respective event. For instance, the date of each public holiday in a given country in a given year. In some instances, the stored collection of enumerated events comprises one or more private events, such as birthdays, anniversaries, graduation ceremonies, or weddings.

Advantageously, in some embodiments, the representation of the event date is updated based on current time in some embodiments. For instance, if Saint Patrick's Day is four days away on Wednesday, then on the next day, Thursday, Saint Patrick's Day should be three days away. Accordingly, in some embodiments this update occurs. In a specific implementation, the representation of the date comprises a countdown to the event date, and the method further comprises, responsive to a trigger to update the electronic message panel, updating the countdown to the event date based on a current time and updating the plurality of objects displayed in the user interface to further include a single object representing (i) the description of the task and (ii) a representation of the event date. In some instances, the trigger to update the electronic message panel is based on a manual request by the recipient to update the user interface. In some embodiments, the trigger to update the electronic message panel occurs without human intervention on a timed recurring basis (e.g., every minute, every three minutes, every time a new message is received, etc.).

In some instances, an object in the one or more objects is a message cluster that represents a plurality of electronic messages. In such embodiments, a semantic analysis of a message body of an incoming electronic message against a set of content-based clustering rules associated with the message cluster is performed. Here, the one or more messages previously assigned to the message cluster are messages that have been received by the recipient and analyzed in accordance with the set of content-based clustering rules. Responsive to a determination that the semantic analysis of the message body of the incoming electronic message satisfies the set of content-based clustering rules, the incoming electronic message is assigned to the message cluster.

Another aspect of the present disclosure provides a computing device comprising one or more processors, memory, and one or more programs stored in the memory. The one or programs are configured for execution by the one or more processors. The one or more programs comprise instructions for displaying a user interface for a messaging application. The user interface comprises an electronic message list panel comprising a plurality of listed objects for the recipient. Each respective object in the plurality of listed objects is visually distinct. An object in the plurality of listed objects represents (i) one or more corresponding electronic messages in a plurality of electronic messages or (ii) a task. A description of a task is obtained. In some instances, obtaining the description of the task comprises receiving the description of the task from the recipient through the user interface. In other instances, the obtaining the description of the task comprises obtaining the description of the task from an object in the plurality of listed objects that represents an electronic message. Responsive to obtaining the description of the task, an event within the description of the task is identified, and from the event, an event date is identified. The plurality of objects displayed in the user interface is updated to include an object that provides a representation of the event date and the task.

Another aspect of the present disclosure provides a non-transitory computer readable storage medium storing one or more programs configured for execution by a computing device having one or more processors and memory. The one or more programs comprise instructions for displaying a user interface for a messaging application. The user interface comprises an electronic message list panel comprising a plurality of listed objects for a recipient. Each respective object in the plurality of listed objects is visually distinct. An object in the plurality of listed objects represents (i) one or more corresponding electronic messages in a plurality of electronic messages or (ii) a task. A description of a task is obtained. In some instances, obtaining the description of the task comprises receiving the description of the task from the recipient through the user interface. In other instances, the obtaining the description of the task comprises obtaining the description of the task from an object in the plurality of listed objects that represents an electronic message. Responsive to obtaining the description of the task, an event within the description of the task is identified independent of user intervention, and from the event, an event date is identified. The plurality of objects displayed in the user interface is updated to include an object that provides a representation of the event date and the task.

### BRIEF DESCRIPTION OF THE DRAWINGS

For a better understanding of the aforementioned implementations of the invention as well as additional implementations thereof, reference should be made to the Description of Implementations below, in conjunction with the following drawings in which like reference numerals refer to corresponding parts throughout the figures.

FIG. 1 illustrates a context in which some implementations operate.

FIG. 2 is a block diagram of a client computing device according to some implementations.

FIG. 3 is a block diagram of a server according to some implementations.

FIGS. 4A-4G illustrate aspects of a user interface for task management in accordance with some implementations.

FIGS. 5A-5C provide a flowchart of a process for task management according to some implementations.

Reference will now be made in detail to implementations, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

### DESCRIPTION OF IMPLEMENTATIONS

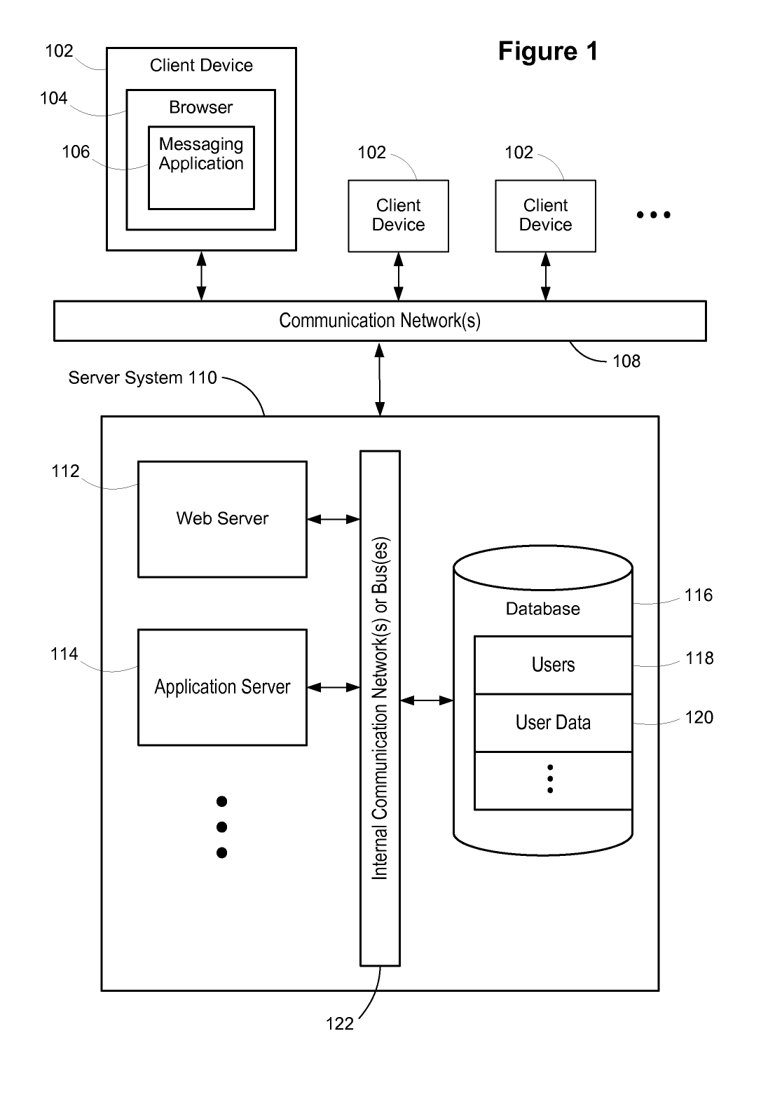

FIG. 1 is a block diagram that illustrates the major components of some implementations. The various client devices 102 (also identified herein as computing devices) and servers 300 in a server system 110 communicate over one or more networks 108 (such as the Internet). A client device 102 may be a smart phone, a tablet computer, a laptop computer, a desktop computer, or other computing device that has access to a communication network 108 and can run a messaging application 106. In some implementations, the messaging application runs within a web browser 104.

In some implementations, the server system 110 consists of a single server 300. More commonly, the server system 110 includes a plurality of servers 300. In some implementations, the servers 300 are connected by an internal communication network of bus 122. The server system 110 includes one or more web servers 112, which receive requests from users (e.g., from client devices 102) and return appropriate information, resources, links, and so on. In some implementations, the server system 110 includes one or more application servers 114, which provide various applications, such as a messaging application 106. The server system 110 typically includes one or more databases 116, which store information such as web pages, a user list 118, and various user information 120 (e.g., user names and encrypted passwords, user preferences, and so on).

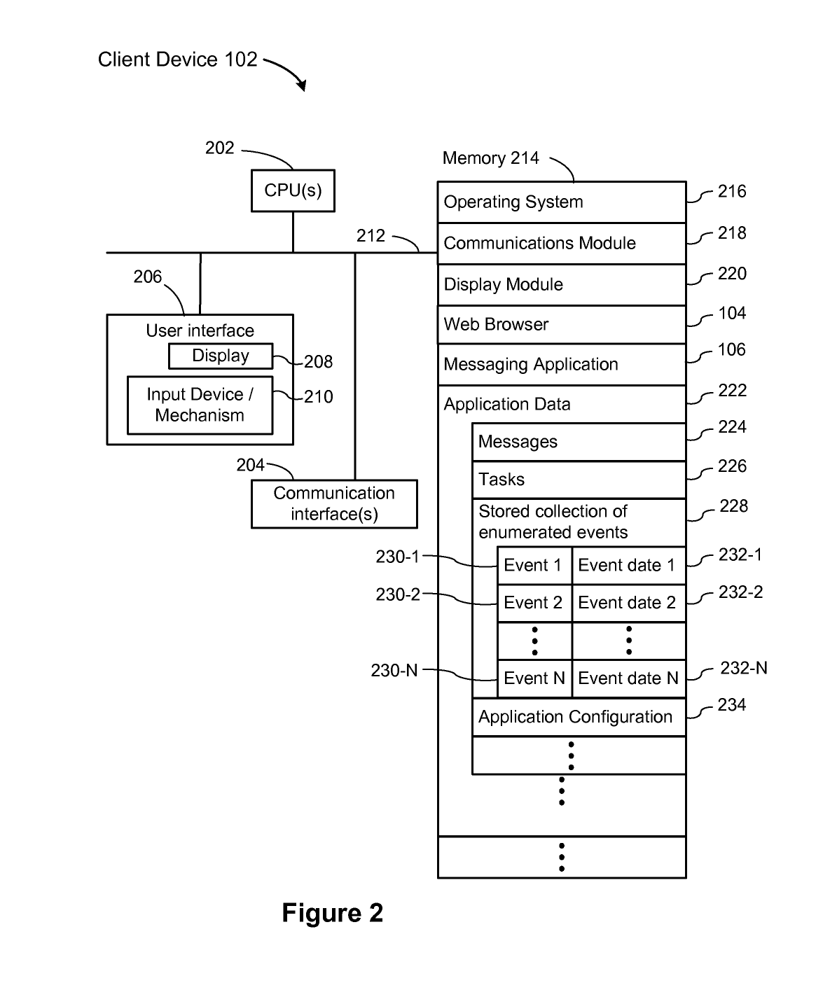

FIG. 2 is a block diagram illustrating a client device 102 that a user uses to access a messaging application 106. A client device is also referred to as a computing device, which may be a tablet computer, a laptop computer, a smart phone, a desktop computer, a PDA, or other computing device than can run a messaging application 106 and has access to a communication network 108. A client device 102 typically includes one or more processing units (CPUs) 202 for executing modules, programs, or instructions stored in memory 214 and thereby performing processing operations; one or more network or other communications interfaces 204; memory 214; and one or more communication buses 212 for interconnecting these components. The communication buses 212 may include circuitry (sometimes called a chipset) that interconnects and controls communications between system components. A client device 102 includes a user interface 206 comprising a display device 208 and one or more input devices or mechanisms 210. In some implementations, the input device/mechanism includes a keyboard and a mouse; in some implementations, the input device/mechanism includes a “soft” keyboard, which is displayed as needed on the display device 208, enabling a user to “press keys” that appear on the display 208.

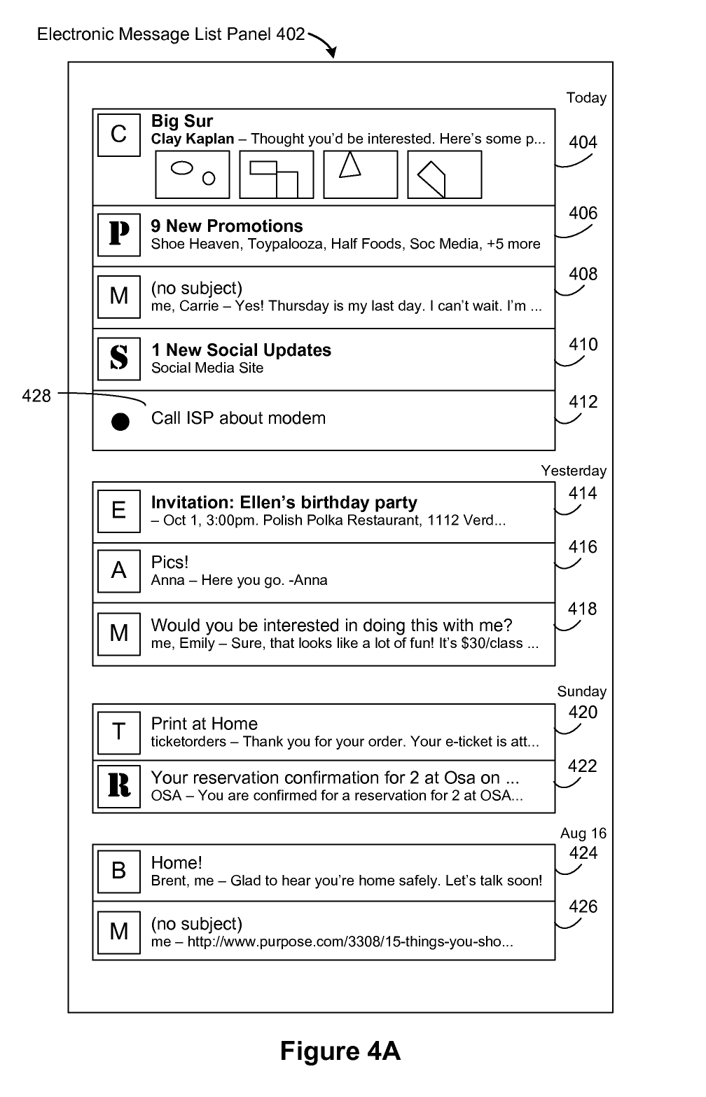

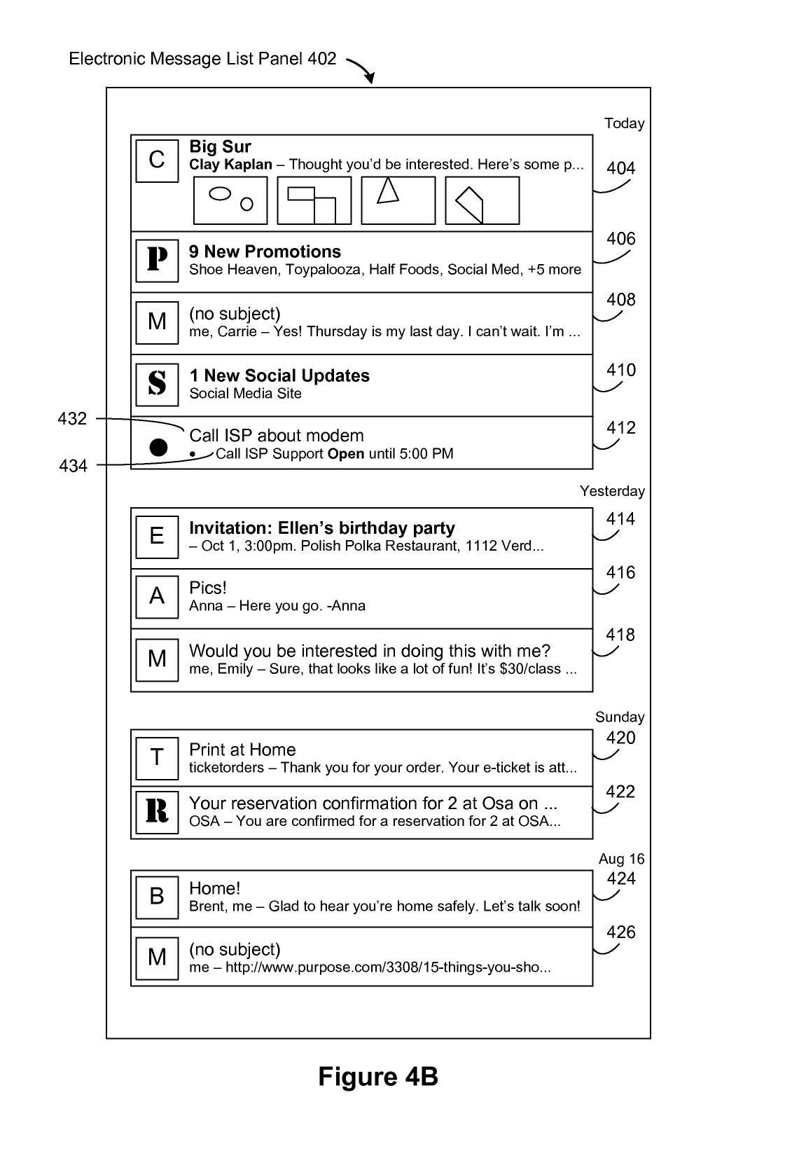

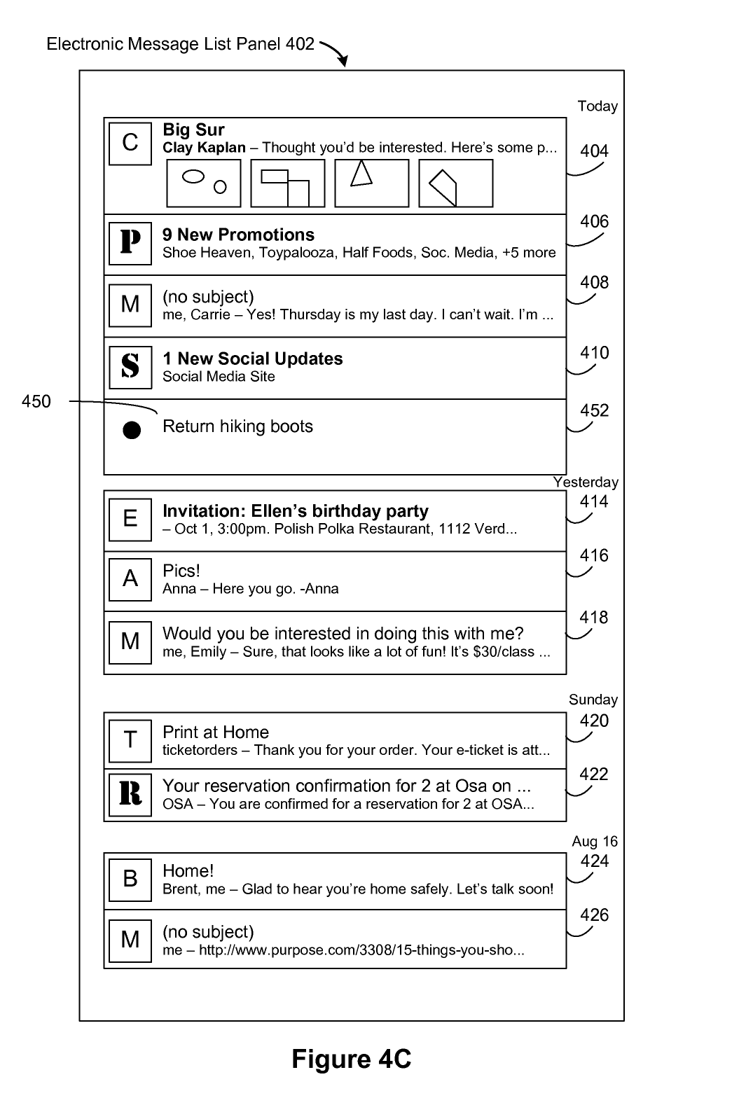

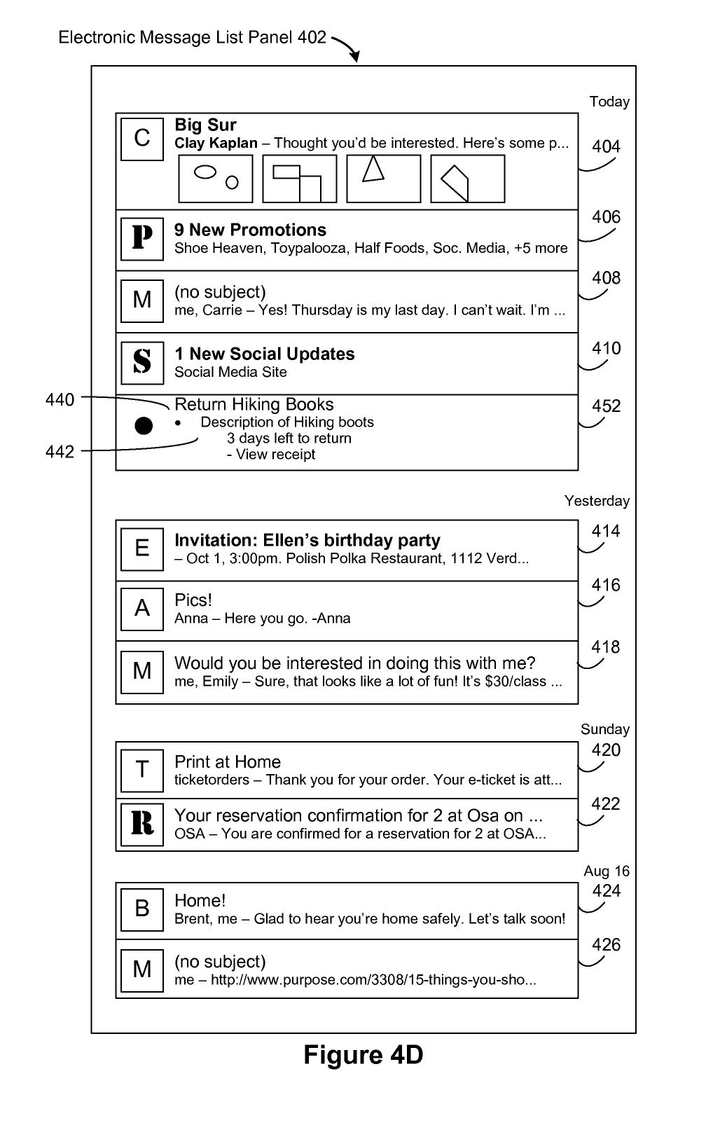

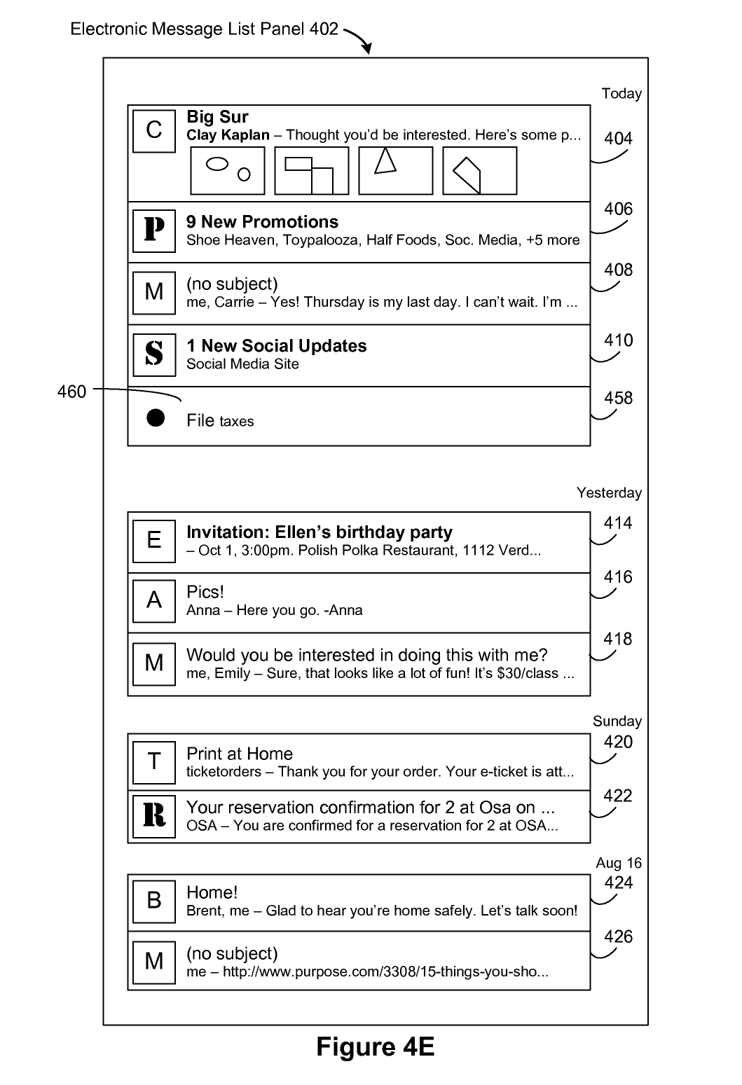

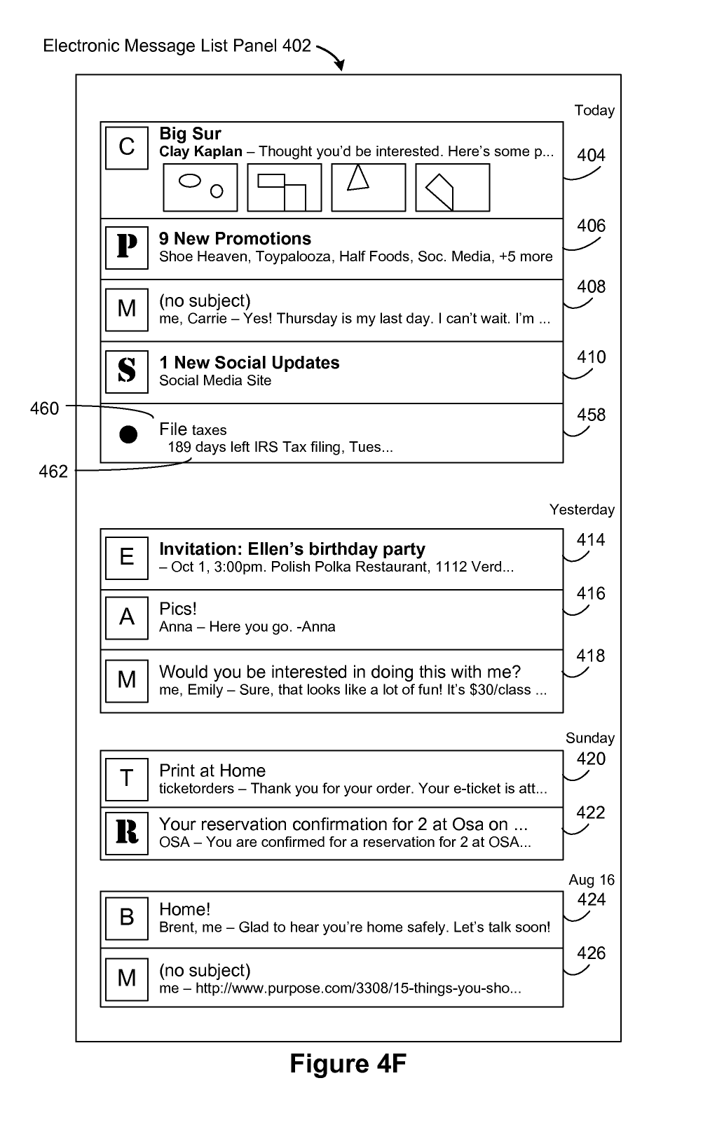

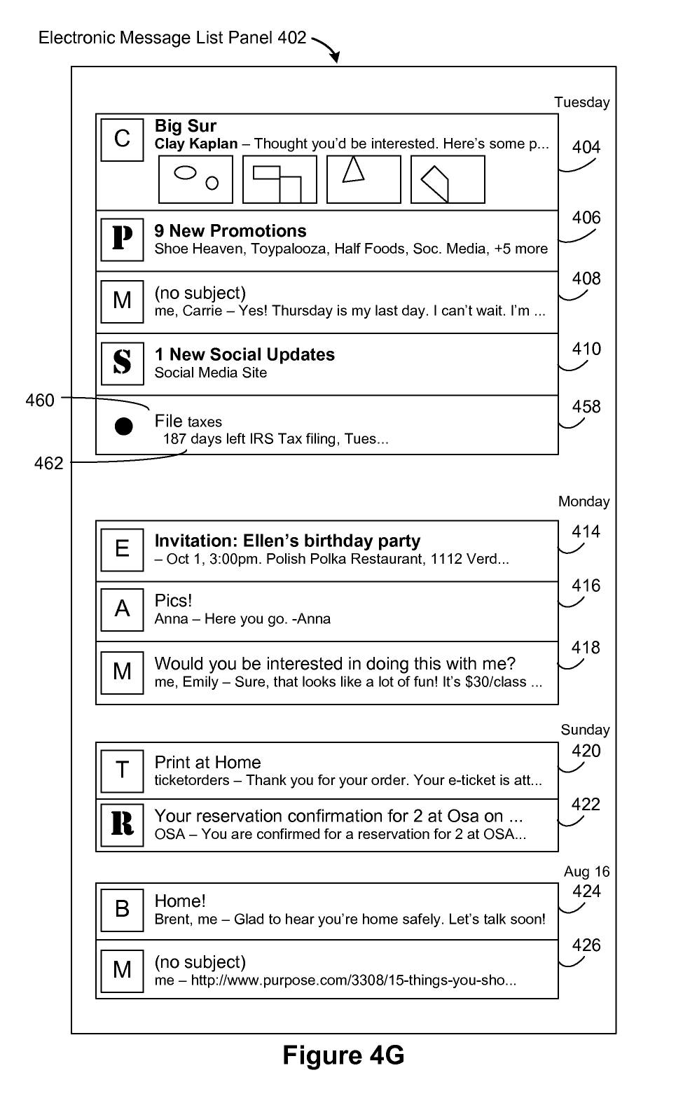

In some implementations, the memory 214 includes high-speed random access memory, such as DRAM, SRAM, DDR RAM or other random access solid state memory devices. In some implementations, memory 214 includes non-volatile memory, such as one or more magnetic disk storage devices, optical disk storage devices, flash memory devices, or other non-volatile solid state storage devices. In some implementations, the memory 214 includes one or more storage devices remotely located from the CPU(s) 202. The memory 214, or alternately the non-volatile memory device(s) within memory 214, comprises a non-transitory computer readable storage medium. In some implementations, the memory 214, or the computer readable storage medium of memory 214, stores the following programs, modules, and data structures, or a subset thereof:
an operating system 216, which includes procedures for handling various basic system services and for performing hardware dependent tasks;
a communications module 218, which is used for connecting the client device 102 to other computers and devices via the one or more communication network interfaces 204 (wired or wireless) and one or more communication networks 108, such as the Internet, other wide area networks, local area networks, metropolitan area networks, and so on;
a display module 220, which receives input from the one or more input devices 210, and generates user interface elements for display on the display device 208;
a web browser 104, which enables a user to communicate over a network 108 (such as the Internet) with remote computers or devices;
a messaging application 106, which enables the user to send and receive electronic messages. In some implementations, the messaging application is an email application. In some implementations, the messaging application is an instant messaging application. In some implementations, the messaging application 106 runs within the web browser 104 as illustrated in FIG. 1. In some implementations, the messaging application 106 runs independently of a web browser 104 (e.g., a desktop application). An example messaging application is illustrated below in FIGS. 4A-4G; and
application data 222, which is used by the messaging application 106. The application data comprises messages 224 (e.g., email messages or instant messages) as well as tasks 226, and information 228 for completing tasks. In some embodiments a task 226 is associated with a message 224. In some embodiments a task 226 is independent of all messages. In some instances, the application data 222 includes a stored collection 228 of enumerated events, where each respective enumerated event 230 in the stored collection 228 of enumerated events is associated with an event date 232. In some instances, the application data 222 includes configuration data 234, such as user preferences, user history, geographic information about the user, or the state of configuration options.

Each of the above identified executable modules, applications, or sets of procedures may be stored in one or more of the previously mentioned memory devices and corresponds to a set of instructions for performing a function described above. The above identified modules or programs (e.g., sets of instructions) need not be implemented as separate software programs, procedures, or modules, and thus various subsets of these modules may be combined or otherwise re-arranged in various implementations. In some implementations, the memory 214 stores a subset of the modules and data structures identified above. Furthermore, in some embodiments, the memory 214 stores additional modules or data structures not described above.

Although FIG. 2 shows a client device 102, FIG. 2 is intended more as a functional description of the various features that may be present rather than as a structural schematic of the implementations described herein. In practice, and as recognized by those of ordinary skill in the art, items shown separately could be combined and some items could be separated.

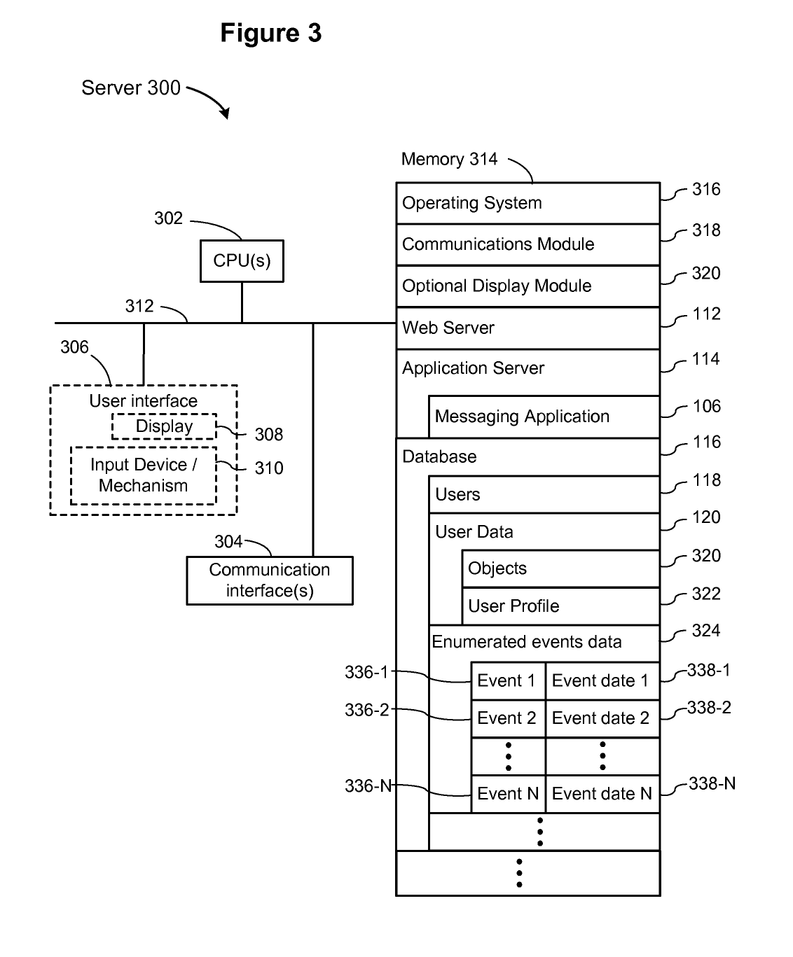

FIG. 3 is a block diagram illustrating a server 300 that is used in a server system 110 in some embodiments. A typical server system includes many individual servers 300 which, in some embodiments, numbers in the hundreds or thousands. A server 300 typically includes one or more processing units (CPUs) 302 for executing modules, programs, or instructions stored in the memory 314 and thereby performing processing operations; one or more network or other communications interfaces 304; memory 314; and one or more communication buses 312 for interconnecting these components. In some embodiments, the communication buses 312 include circuitry (sometimes called a chipset) that interconnects and controls communications between system components. In some implementations, a server 300 includes a user interface 306, which may include a display device 308 and one or more input devices 310, such as a keyboard and a mouse.

In some implementations, the memory 314 includes high-speed random access memory, such as DRAM, SRAM, DDR RAM or other random access solid state memory devices. In some implementations, the memory 314 includes non-volatile memory, such as one or more magnetic disk storage devices, optical disk storage devices, flash memory devices, or other non-volatile solid state storage devices. In some implementations, the memory 314 includes one or more storage devices remotely located from the CPU(s) 302. The memory 314, or alternately the non-volatile memory device(s) within memory 314, comprises a non-transitory computer readable storage medium. In some implementations, the memory 314, or the computer readable storage medium of memory 314, stores the following programs, modules, and data structures, or a subset thereof:
an operating system 316, which includes procedures for handling various basic system services and for performing hardware dependent tasks;
a communications module 318, which is used for connecting the server 300 to other computers via the one or more communication network interfaces 304 (wired or wireless), an internal network or bus 122, or other communication networks 108, such as the Internet, other wide area networks, local area networks, metropolitan area networks, and so on;
an optional display module 320, which receives input from one or more input devices 310, and generates user interface elements for display on a display device 308;
one or more web servers 112, which receive requests from client device 102, and returns responsive web pages, resources, or links. In some implementations, each request is logged in the database 116;
one or more application servers 114, which provide various applications (such as an email or other messaging application) to client devices 102. In some instances, applications are provided as a set of web pages, which are delivered to client devices 102 and displayed in a web browser 104. The web pages are delivered as needed or requested. In some instances, an application is delivered to a client device 102 as a download, which is installed and run from the client device 102 outside of a web browser 104;
one or more databases 116, which store various data used by the modules or programs identified above. In some implementations, the database 116 includes a list of authorized users 118, which may include user names, encrypted passwords, and other relevant information about each user. The database 116 also stores user specific data 120 that is used by one or more of the applications provided by the application server. For example, some implementations store the objects 320 for each user. As another example, some implementations store user profiles 322 associated with users. In some implementations, the database 116 includes enumerated events data 324 including, for each enumerated event 336, a corresponding event date 338.

Event dates 232 and/or 338 are in any form that tracks time to any degree of precision suitable for the corresponding event 230/336. In some instances, as an example, the event 230/336 is a public holiday and the event date 232/338 is a calendar date. In some instances, as another example, the event 230/336 is a wedding ceremony and the event date 232/338 is a time of day on a specified calendar date. In some instances, as yet another example, the event 230/336 is a recurring daily event, such as a time to take a medicine or a store closing time and the event date 232/338 is a time of day. Moreover, it will be appreciated that FIGS. 2 and 3 collectively represent the server 300 and the client device 102 as including events with corresponding dates. In some implementations, only the server 300 stores events with corresponding dates. In some implementations, only the client device 102 stores events with corresponding dates. In some implementations, both the server 300 and the client device 102 stores events with corresponding dates. In some such implementations, the server 300 and the client device 102 store the same events with corresponding dates. In some such implementations, the server 300 stores a first set of events and dates and the client device 102 stores a second set of events and dates, and there may be no overlap between the first set of events and dates and the second set of events and dates, partial overlap between the first set of events and dates and the second set of events and dates, or complete overlap between the first set of events and dates and the second set of events and dates. In one embodiment, the first set of events is public events, and the second set of events is unique to a particular user associated with a particular client device 102.

Each of the above identified elements in FIG. 3 is stored in one or more of the previously mentioned memory devices. Each executable program, module, or procedure corresponds to a set of instructions for performing a function described above. The above identified modules or programs (e.g., sets of instructions) need not be implemented as separate software programs, procedures or modules, and thus various subsets of these modules are combined or otherwise re-arranged in various implementations. In some implementations, the memory 314 stores a subset of the modules and data structures identified above. Furthermore, in some embodiments, the memory 314 stores additional modules or data structures not described above.

Although FIG. 3 illustrates a server 300, FIG. 3 is intended more as functional illustration of the various features that may be present in a set of one or more servers rather than as a structural schematic of the implementations described herein. In practice, and as recognized by those of ordinary skill in the art, items shown separately could be combined and some items could be separated. The actual number of servers used to implement these features, and how features are allocated among them, will vary from one implementation to another, and may depend in part on the amount of data traffic that the system must handle during peak usage periods as well as during average usage periods.

As illustrated in FIGS. 2 and 3, the functionality for a messaging application may be shared between a client device 102 and a server system 110. In some implementations, after the messaging application is installed on a client device 102, the majority of the subsequent processing occurs on the client device. For example, as described above, events and their corresponding event dates may be stored solely at the client device, and not on a server 300. In other implementations, the majority of the processing and data storage occurs at a server 300, and the client device 102 uses a web browser 104 to view and interact with the data. For example, events and their corresponding event dates may be stored only at the server system 110. One of skill in the art recognizes that various allocations of functionality between the client device 102 and the server system 110 are possible, and some implementations support multiple configurations (e.g., based on user selection).

FIG. 4A illustrates features of a messaging application that supports task management in accordance with some implementations. FIG. 4A illustrates an electronic message list panel 402, which may be displayed as part of an electronic messaging application (e.g., an email application). In this example, each row in the list represents a separate object (e.g., messages 404, 408, and 414-426), a separate message cluster (e.g., 406, 410), or a task 412. The objects all are intended for a recipient associated with the message list panel 402. In some embodiments, individual messages (e.g., messages 404, 408, and 414-426) are message threads, message conversations, or messages that are addressed to one or more users, including the recipient uniquely associated with the electronic message list panel 402.

In FIG. 4A, the electronic message list panel 402 is, in particular, shown to comprise two message clusters, cluster 406 and cluster 410. Cluster 406 is a group of electronic messages having a collective association, namely promotional material (e.g., advertisements for retail sales, newsletters from stores). As can be seen in FIG. 4A, cluster 406 comprises nine new electronic messages, and cluster 410 comprises 1 new electronic message. In some embodiments, a new electronic message refers to a message that has not been viewed, opened, acknowledged or read by the user of the messaging application. Message clusters are disclosed further in U.S. patent application Ser. No. 14/145,005, entitled “Systems and Methods for Throttling Display of Electronic Messages,” filed Dec. 31, 2013, and U.S. patent application Ser. No. 14/139,205, entitled “Systems and Methods for Clustering Electronic Messages,” filed Dec. 23, 2013, each of which is hereby incorporated by reference herein in its entirety.

Continuing to refer to FIG. 4A, task management is disclosed in more detail. A description of a task 428 associated with a recipient is obtained. In some instances the recipient creates the description of the task 428 by direct input (e.g. through a keypad interface). In other instances, the task is inferred from an object in the electronic message list panel 402. Ways to infer a task from an object, such as an email, are disclosed in U.S. patent application Ser. No. 14/161,368, entitled “Identifying Tasks in Messages,” filed Jan. 22, 2014, which is hereby incorporated by reference herein in its entirety.

Responsive to obtaining the description of the task, an event within the description of the task is identified independent of user intervention. In some embodiments, the identifying the event date is based, at least in part, upon the description of the task and stored information associated with the recipient. For example, consider task 412 of FIG. 4A in which the description 428 of the task 412 is “Call ISP about modem.” From this task description, an event, the closing time of the user's Internet service provider (ISP), is identified. In some embodiments, the identity of the service provider is determined from this task description and the user's contact information. For instance, the ISP provider that is in the user's contact list. In other embodiments, the identity of the service provider is determined from a user profile associated with the recipient. In some embodiments, the identity of the service provider is determined from the recipient's ISP address. In some embodiments, identification of the event within the description of the task uses non-transient stored geographic information (e.g., a residence of a recipient) about the recipient to identify the event. For instance, in some such embodiments, geographic information about the recipient is used to determine which ISP the recipient will likely want to call. Regardless of how the ISP is identified, the event in the example illustrated in FIG. 4A is the closing time of the ISP. Accordingly, an event date for the event is identified. In some embodiments, referring to FIG. 2, this event date is acquired using the stored collection of enumerated events 228 stored in a client device associated with the recipient. In some embodiments, referring to FIG. 3, this event date is acquired using the enumerated events data 324 stored in server 300. Once the event date is acquired, the list of objects in the electronic message list panel 402 is updated to include an object that provides a representation of the event date and the task. With reference to the example of FIG. 4A, this object update involves updating the already existing object 412 to provide a representation 434 of the event date, as illustrated in FIG. 4B.

Turning to FIGS. 4C and 4D, an example of the present disclosure is provided that illustrates an instance where the representation of an event date is a countdown to the event date. As in the example provided by FIGS. 4A and 4B, a description of a task 428 associated with a recipient is obtained. In some instances the recipient creates the description of the task 428 by direct input (e.g. through a keypad interface). In other instances, the description of the task is inferred from an object in the electronic message list panel 402. In still other instances, the description of the task is appended by the recipient to an electronic message in the message list panel.

Responsive to obtaining the description of the task, an event within the description of the task is identified. In the example provided by FIGS. 4C and 4D, the event is returning the item hiking boots. The identity of the store to which the hiking boots is to be returned is determined in any number of different ways depending upon the context under which the description of the task was obtained. For instance, if the description of the task was obtained from an annotated email from a merchant reporting the purchase of the hiking boots, the store identity, and thus the full representation of the event in this example, is derived directly from this source. Alternatively, if the task is a standalone task, not associated with an email, some embodiments of the present disclosure will use stored information about the recipient, such as the recipient's geographical location, recipient preferences, contact lists, or recipient profile to determine the identity of the store. Once the event is fully defined, an event date for the event is determined. The full definition of the event in the example of FIGS. 4C and 4D is “return hiking boots to store X before the expiration of store X's return policy.” From this full definition of the event, an event date is determined. In some embodiments, this event date is determined from enumerated events data 324 and/or the stored collection of enumerated events 228. For instance, in some embodiments, such data sources store as event dates the return policy periods of specific merchants. With the event date identified, the plurality of objects displayed in the user interface is updated to include an object that provides a representation of the event date and the description of the task. Specifically, referring to FIG. 4D, object 452 is updated to specify how many days (element 442) are left to return the hiking boots.

Turning to FIGS. 4E through 4G, an example of the present disclosure is provided that illustrates an instance where the representation of an event date is an explicit deadline. As in the examples provided by FIGS. 4A through 4D, a description of a task 460 associated with a recipient is obtained as illustrated by FIG. 4E. Responsive to obtaining the description 460 of the task, an event within the description of the task is identified. In the example provided by FIG. 4E, the event is filing taxes. The identity of the government agency that this task is associated with is determined in any number of different ways in accordance with the present disclosure. Some embodiments of the present disclosure will use stored information about the recipient, such as the recipient's stated geographical location, recipient preferences such as default language, contact lists, or user profile to determine the identity of the government agency. Some embodiments of the present disclosure will use dynamic information about the recipient, such as the recipient's actual geographical location, the recipient's present ISP address, or the version of the messaging application the recipient is using to determine the identity of the entity associated with the task. In some instances, the complete description of the entity associated with the task is explicitly defined in the task description. Once the event is fully defined, an event date for the event is determined. The full definition of the event in the example of FIGS. 4E and 4F is “File taxes by the U.S. internal revenue tax deadline.” From this full definition of the event, an event date is determined. In some embodiments, this event date is determined from enumerated events data 324 and/or the stored collection of enumerated events 228. For instance, in some embodiments, such data sources store as event dates the tax deadlines of specific government agencies. For the United States, for example, some embodiments of the present disclosure store federal, state and county tax deadlines. In such an example, identifying the event date comprises retrieving a stored collection of enumerated events (e.g., enumerated events data 324 and/or the stored collection of enumerated events 228), where each respective enumerated event in the stored collection of enumerated events is associated with an event date, and matching the event (e.g., “U.S. internal revenue tax deadline”) to an enumerated event in the stored collection of enumerated events. In some embodiments, the enumerated events in the stored collection of enumerated events comprise one or more public events (e.g., a tax filing deadline, a deadline to register to vote, a deadline to vote in public election, a public holiday, or a ticketed event). In some embodiments, the enumerated events in the stored collection of enumerated events comprise one or more private events (e.g., is a birthday, anniversary, graduation ceremony, or wedding). With the event date identified, the plurality of objects displayed in the user interface is updated to include an object that provides a representation of the event date and the description of the task. Specifically, referring to FIG. 4F, object 458 is updated to specify how many days (element 462) are left to file taxes with the IRS.

In FIG. 4F, the representation of the event date is a countdown to the event date. In some embodiments, responsive to a trigger to update the electronic message panel the countdown to the event date is updated based on a current time and the plurality of objects displayed in the user interface is updated to further include a single object representing (i) the description of the task and (ii) a representation of the event date. In some instances, the trigger to update the electronic message panel is based on a manual request by the recipient to update the user interface. In some instance, the trigger to update the electronic message panel occurs without human intervention on a timed recurring basis. FIG. 4G illustrates the electronic message list panel after such an update. In FIG. 4G, two days have elapsed since the depiction shown in FIG. 4E. Therefore, object 458 is updated to reflect that there are now only 187 days left for the IRS filing.

In another example, the task description is “Call ISP about modem.” From this task description, a first event, the closing time of the recipient's Internet service provider (ISP), is identified. In some embodiments, the identity of the service provider is determined from this task description and the recipient's contact information. For instance, the ISP provider that is in the recipient's contact list. In other embodiments, the identity of the service provider is determined from a user profile associated with the recipient. In still other embodiments, the identity of the service provider is determined from the recipient's ISP address. Regardless of how the ISP is identified, the event date in this example is the closing time of the ISP. Accordingly, an event date for the first event is identified. In some embodiments, this event date is acquired using the stored collection of enumerated events 228 stored in a client device associated with the recipient. In some embodiments, referring to FIG. 3, this event date is acquired using the enumerated events data 324 stored in server 300. Once the event date is acquired, the list of objects in the electronic message list panel is updated to include an object that provides a representation of the first event date and the task. In this example, this object update involves updating an already existing object that included the task description to provide a representation of the event date.

In some instances, the task description includes a task action and the representation of the event date is time of day when an associated entity will stop receiving requests to perform the action or is an amount of time before the entity will stop receiving requests to perform the action. In some embodiments, identifying an entity associated with the task comprises retrieving non-transient stored geographical information about the recipient. In some such embodiments, the information is stored as a user profile. For example, referring to FIG. 3, in some embodiments the non-transient stored geographical information about the recipient is stored in a user profile 322 uniquely associated with the recipient. In some instances, the entity associated with a task is identified by retrieving the geographical information about the recipient from a wireless device associated with the recipient. In some such instances, the geographical information is a present location of the recipient. In other instances, the geographical information is a geographic position, such as a street address, that the recipient has provided for storage in a profile (e.g., user profile 322 of FIG. 3) or other form of record associated with the recipient. In some embodiments, identification of an event date is determined based on the description of the task. For example, if the description of the task is “repair automobile”, the event date is the closing time of an automobile repair facility. Alternatively, if the description of the task is “wash car”, the event date is the closing time of a car wash. Alternatively still, if the description of the task is “donate car”, the event date is the closing time of a nearby nonprofit agency that accepts automobiles.

Referring to FIG. 2, a display device 208 is inherently limited in size. Accordingly, the number of objects displayed in the electronic message list panel 402 is necessarily limited. Scrolling may be necessary for a recipient to get to a desired object. If the number of objects in the message list is small enough, all of the objects may be able to be displayed.

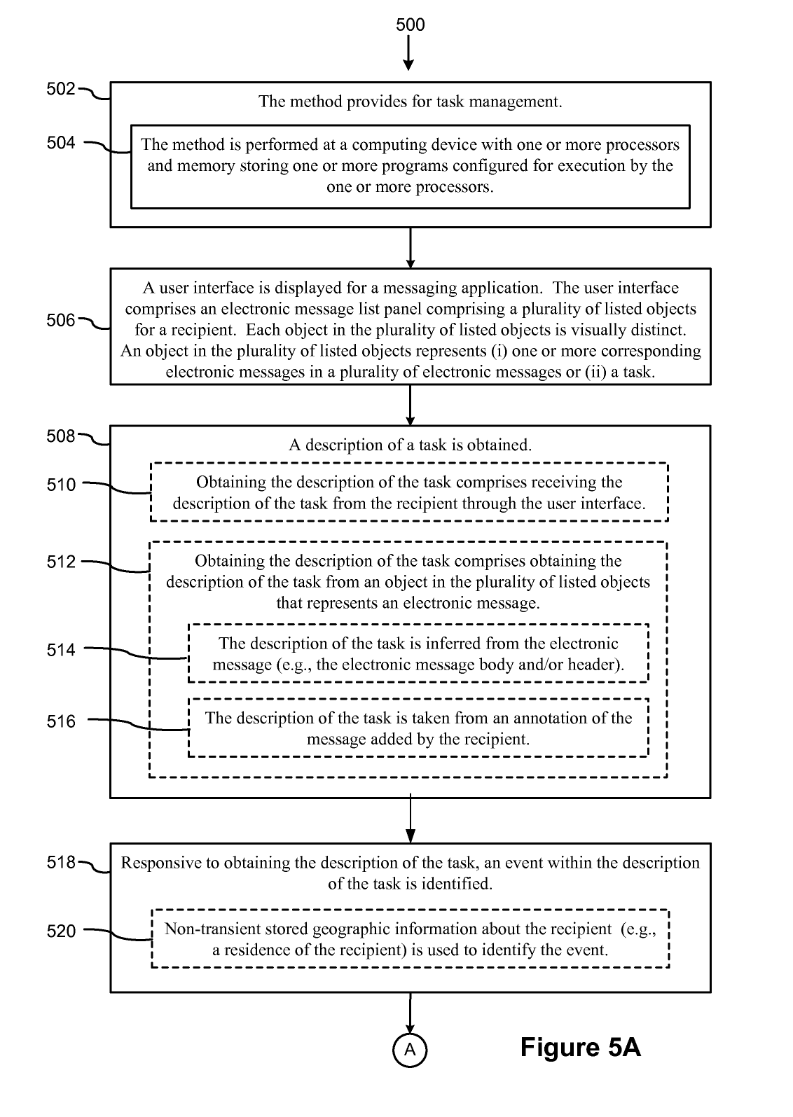

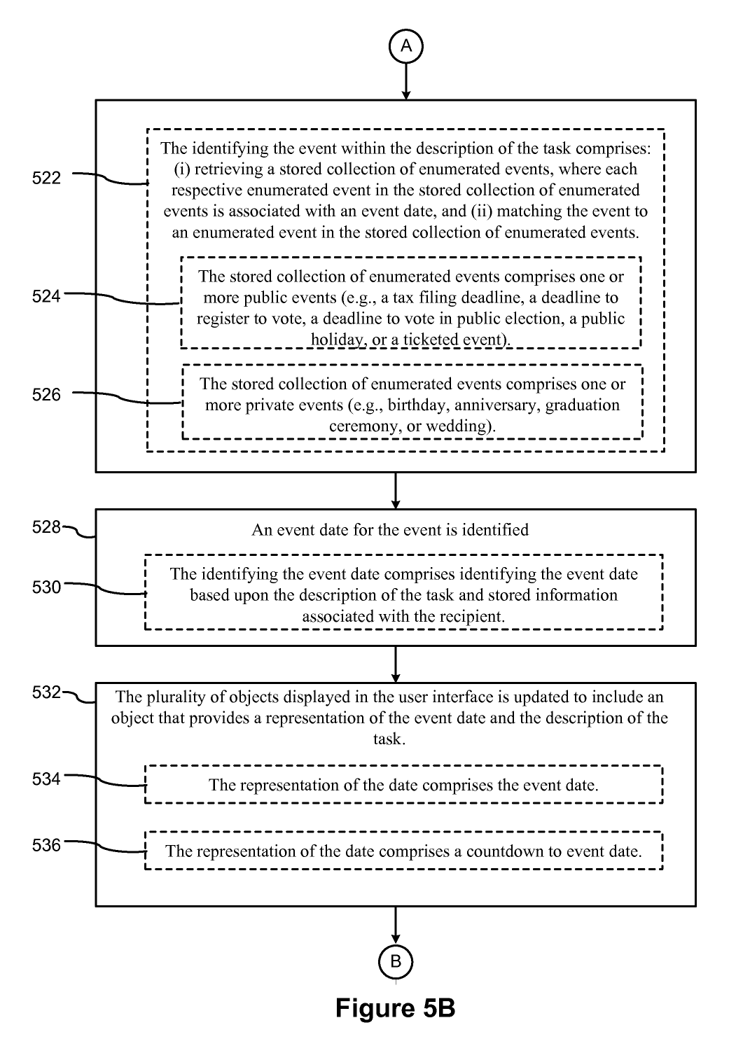

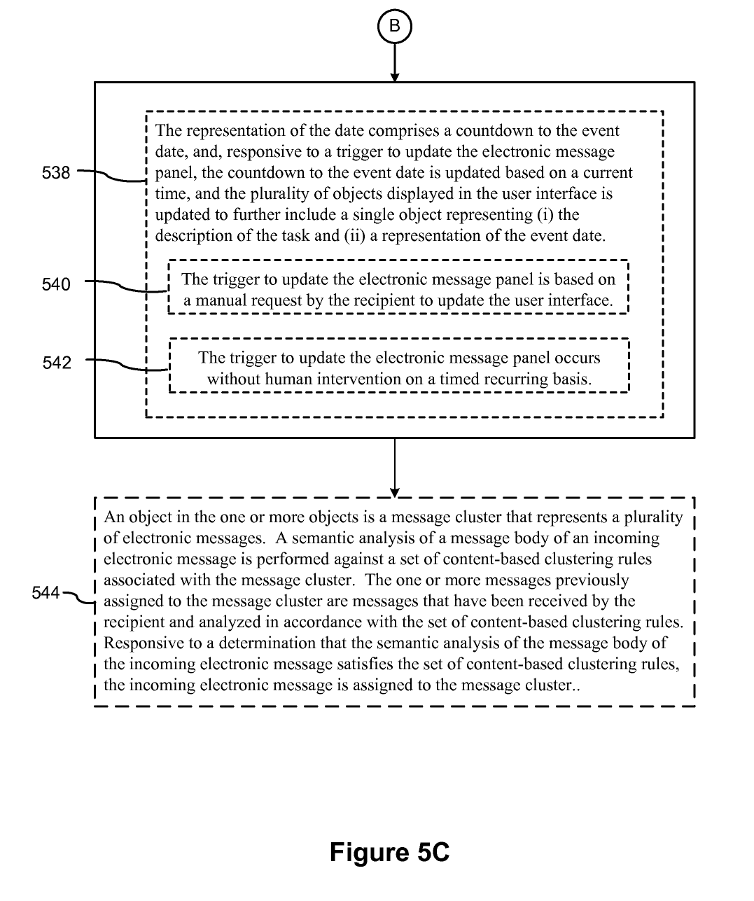

FIGS. 5A-5C provide a flowchart of a process 500, performed by a computing device, for providing task management (502). The method is performed (504) at a computing device 102 and/or 110 having one or more processors and memory. The memory stores (504) one or more programs configured for execution by the one or more processors. A user interface for a messaging application is displayed (506). The user interface comprises an electronic message list panel comprising a plurality of listed objects. Each respective object in the plurality of listed objects is visually distinct (506). An object in the plurality of listed objects represents (i) one or more corresponding electronic messages in a plurality of electronic messages or (ii) a task. More typically, many if not all the objects in the plurality of listed objects each represent (i) one or more corresponding electronic messages in a plurality of electronic messages or (ii) a task. For instance, some of the objects represent single messages, some of the objects represent message clusters, and some of the messages represent tasks. In some embodiments, other types of objects are possible as well, such as conversations.

A description of a task is obtained (508). In some instances, the description of the task comprises receiving the description of the task from the recipient through the user interface (510). In one example of such an instance, a prompt for a new task entry is provided and the recipient enters the description of the task through the user interface. The task is then added as an independent object to the plurality of listed objects. In other instances, obtaining the description of the task comprises obtaining the description of the task from an object in the plurality of listed objects that represents an electronic message (512). In some such instances, the description of the task is inferred from the electronic message (e.g., the electronic message body and/or header) (514). In other instances, the recipient annotated the electronic message and obtaining the description of the task comprises obtaining the task from the annotation provided by the recipient (516).

Responsive to obtaining the description of the task, an event within the description of the task is identified (518). In some embodiments, indentifying the event within the description of the task is done independent of user intervention. For example, in some embodiments, the event is identified within the description of the task independent of user intervention using non-transient stored geographic information about the recipient (e.g., a permanent residence of the recipient, calendar information associated with the recipient, a present location associated with the recipient, etc.).

In some embodiments, the identifying the event within the description of the task is done independent of user intervention by retrieving a stored collection of enumerated events, where each respective enumerated event in the stored collection of enumerated events is associated with an event date, and by matching the event to an enumerated event in the stored collection of enumerated events (522). When there is a match between the obtained event and the enumerated event, the event date associated with the enumerated event is used. In some embodiments, the stored collection of enumerated events comprises one or more public events (e.g., a tax filing deadline, a deadline to register to vote, a deadline to vote in public election, a public holiday, or a ticketed event) (524). In some embodiments, the stored collection of enumerated events comprises one or more private events (e.g., birthday, anniversary, graduation ceremony, or wedding) (526).

The method further comprises identifying an event date (528). In some embodiments identifying the event date is based upon the description of the task and stored information associated with the recipient (530). The method further comprises updating the plurality of objects displayed on the recipient interface to include an object that provides a representation of the event date and the description of the task (532). In some embodiments, the representation of the date comprises the event date (534). For instance, in some embodiments the event is a public holiday and the representation of the date comprises the date of the public holiday. In some embodiments, the representation of the date comprises a countdown to the event date (536). For instance, in some embodiments the event is a public holiday and the representation of the date comprises the number of days until the public holiday will next occur. In some embodiments, the representation of the date comprises a countdown to the event date, and, responsive to a trigger to update the electronic message panel, the countdown to the event date is updated based on a current time and the plurality of objects displayed in the user interface is updated to further include a single object representing (i) the description of the task and (ii) a representation of the event date (538). Such an embodiment is further disclosed with reference to FIGS. 4E through 4G above. In some embodiments, the trigger to update the electronic message panel is based on a manual request by the recipient to update the user interface (540). In some alternative embodiments, the trigger to update the electronic message panel occurs without human intervention on a timed recurring basis (542).

Optionally, in some embodiments, an object in the one or more objects is a message cluster that represents a plurality of electronic messages, and the method further comprises performing a semantic analysis of a message body of an incoming electronic message against a set of content-based clustering rules associated with the message cluster, where the one or more messages previously assigned to the message cluster are messages that have been received by the recipient and analyzed in accordance with the set of content-based clustering rules, and, responsive to a determination that the semantic analysis of the message body of the incoming electronic message satisfies the set of content-based clustering rules, the incoming electronic message is assigned to the message cluster (544).

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to best explain the principles of the invention and its practical applications, to thereby enable others skilled in the art to best utilize the invention and various implementations with various modifications as are suited to the particular use contemplated.

What is claimed is:

1. A method of task management, comprising:
at a computing device having one or more processors and memory storing one or more programs configured for execution by the one or more processors:
displaying a user interface for a messaging application, the user interface comprising an electronic message list panel comprising a plurality of listed objects for a recipient, wherein each respective object in the plurality of listed objects is visually distinct and wherein an object in the plurality of listed objects represents (i) one or more corresponding electronic messages in a plurality of electronic messages or (ii) a task;
obtaining a description of a task;
responsive to obtaining the description of the task, identifying an event within the description of the task independent of user intervention;
identifying an event date for the event; and
updating the plurality of objects displayed in the user interface to include an object that provides a representation of the event date and the description of the task.

2. The method of claim 1, wherein the identifying the event date comprises identifying the event date based upon the description of the task and stored information associated with the recipient.

3. The method of claim 1, wherein the representation of the date comprises the event date.

4. The method of claim 1, wherein the representation of the date comprises a countdown to the event date.

5. The method of claim 1, wherein the identifying the event within the description of the task uses non-transient stored geographic information about the recipient to identify the event.

6. The method of claim 5, wherein the non-transient stored geographic information about the recipient is a residence of the user.

7. The method of claim 1, wherein the identifying the event date comprises:
retrieving a stored collection of enumerated events, wherein each respective enumerated event in the stored collection of enumerated events is associated with an event date; and
matching the event to an enumerated event in the stored collection of enumerated events.

8. The method of claim 7, wherein the stored collection of enumerated events comprises one or more public events.

9. The method of claim 8, wherein a public event in the one or more public events is a tax filing deadline, a deadline to register to vote, a deadline to vote in public election, a public holiday, or a ticketed event.

10. The method of claim 7, wherein the stored collection of enumerated events comprises one or more private events.

11. The method of claim 10, wherein a private event in the one or more private events is a birthday, anniversary, graduation ceremony, or wedding.

12. The method of claim 1, wherein the representation of the date comprises a countdown to the event date, the method further comprising:
responsive to a trigger to update the electronic message panel:
updating the countdown to the event date based on a current time; and
updating the plurality of objects displayed in the user interface to further include a single object representing (i) the description of the task and (ii) a representation of the event date.

13. The method of claim 12 wherein the trigger to update the electronic message panel is based on a manual request by the recipient to update the user interface.

14. The method of claim 12 wherein the trigger to update the electronic message panel occurs without human intervention on a timed recurring basis.

15. The method of claim 1, wherein an object in the one or more objects is a message cluster that represents a plurality of electronic messages, the method further comprising:
performing a semantic analysis of a message body of an incoming electronic message against a set of content-based clustering rules associated with the message cluster, wherein the one or more messages previously assigned to the message cluster are messages that have been received by the recipient and analyzed in accordance with the set of content-based clustering rules; and
responsive to a determination that the semantic analysis of the message body of the incoming electronic message satisfies the set of content-based clustering rules, assigning the incoming electronic message to the message cluster.

16. The method of claim 1, the obtaining the description of the task comprises receiving the description of the task from the recipient through the user interface.

17. The method of claim 1, wherein obtaining the description of the task comprises obtaining the description of the task from an object in the plurality of listed objects that represents an electronic message.

18. The method of claim 1, wherein two or more objects in the plurality of listed objects are ordered based on a time sent to the recipient.

19. A computing device, comprising:
one or more processors;
memory; and
one or more programs stored in the memory configured for execution by the one or more processors, the one or more programs comprising instructions for:
displaying a user interface for a messaging application, the user interface comprising an electronic message list panel comprising a plurality of listed objects for a recipient, wherein each respective object in the plurality of listed objects is visually distinct and wherein an object in the plurality of listed objects represents (i) one or more corresponding electronic messages in a plurality of electronic messages or (ii) a task;
obtaining a description of a task;
responsive to obtaining the description of the task, identifying an event within the description of the task independent of user intervention;
identifying an event date for the event; and
updating the plurality of objects displayed in the user interface to include an object that provides a representation of the event date and the description of the task.

20. A non-transitory computer readable storage medium storing one or more programs configured for execution by a computing device having one or more processors and memory, the one or more programs comprising instructions for:
displaying a user interface for a messaging application, the user interface comprising an electronic message list panel comprising a plurality of listed objects for a recipient, wherein each respective object in the plurality of listed objects is visually distinct and wherein an object in the plurality of listed objects represents (i) one or more corresponding electronic messages in a plurality of electronic messages or (ii) a task;
obtaining a description of a task;
responsive to obtaining the description of the task, identifying an event within the description of the task independent of user intervention;
identifying an event date for the event; and
updating the plurality of objects displayed in the user interface to include an object that provides a representation of the event date and the description of the task.
